(19) United States
(12) Patent Application Publication
(10) Pub. No.: US 2013/0061274 A1
(43) Pub. Date: Mar. 7, 2013

(54) APPARATUS AND METHOD FOR MANAGING A PLURALITY OF SERVICES

(71) Applicants: Jong-Cheol KIM, Seoul (KR); Chan-Hui KANG, Yongin-si (KR)

(72) Inventors: Jong-Cheol KIM, Seoul (KR); Chan-Hui KANG, Yongin-si (KR)

(73) Assignee: KT CORPORATION, Seongnam-city (KR)

(21) Appl. No.: 13/606,882

(22) Filed: Sep. 7, 2012

(30) Foreign Application Priority Data
Sep. 7, 2011 (KR) 10-2011-0090808

(51) Int. Cl. H04N 21/00

(52) U.S. Cl. 725/93

(57) ABSTRACT

An apparatus for managing a plurality of services is disclosed. The apparatus includes a communication unit configured to receive a message that requests initiation of at least one of the plurality of services from at least one of a plurality of user devices through a network, a plurality of service providing platforms configured to provide the plurality of services to the plurality of user devices, and a service management unit configured to, when a message that requests initiation of a first service of the plurality of services is received from a first user device by the communication unit, send a control command for initiating a connection of a first service providing platform, which provides the first service among the plurality of service providing platforms, with the first user device.

### CROSS-REFERENCE TO RELATED APPLICATION

This application claims priority from Korean Patent Application No. 10-2011-0090808, filed on Sep. 7, 2011, in the Korean Intellectual Property Office, the entire disclosure of which is incorporated herein by reference in its entirety.

### BACKGROUND

1. Field

Apparatuses and methods consistent with exemplary embodiments relate to a service management apparatus and method.

2. Description of the Related Art

Recently, as the number of users enjoying multimedia contents increases, a technology for seamlessly downloading multimedia contents (e.g., moving picture contents) that a user has been watching through a certain mobile device or multimedia device in another device is being developed.

In this regard, disclosed in Korean Patent Publication No. 2011-0026650 (Title: Apparatus and Method for Providing Contents Receiving Device Change Service) is a technology for, if a device change service is requested while certain contents are being played in one device, selecting a device in which the contents will be played seamlessly and playing the contents in the selected device.

In order to provide the same contents to the different devices, a controller (hereinafter, a service providing platform) needs to change the contents according to the specifications of the devices before providing the contents.

However, there exists a wide variety of contents (services). By way of non-limiting example, there are Internet Protocol Television (IPTV) real-time broadcasting and Video on Demand (VOD) broadcasting services, Internet services, streaming game services, video phone services, social network services (SNS), home robot video monitoring services, control services, and so forth.

Conventionally, in order to provide such a wide variety of services to different kinds of devices from different service providing platforms, each service providing platform needs to perform a service control and a status management for the devices for each of the services that are provided.

As in this conventional method, if the service providing platforms control the devices and manage the statuses thereof for each of the services, a multiple number of service providing platforms respectively perform session managements for a single device. Accordingly, waste in management cost due to redundant session management may be caused.

Further, when service interworking between the devices is required to provide a certain service, a service that a device is currently providing may conflict with an interworking service, resulting in a failure to provide the target service.

### SUMMARY

In order to address the above-described conventional problems, exemplary embodiments provide a service management apparatus and method for controlling and managing services between devices and service providing platforms for providing various services.

According to an aspect of an exemplary embodiment, an apparatus for managing a plurality of services is provided. The apparatus may include a communication unit configured to receive a message that requests initiation of at least one of the plurality of services from at least one of a plurality of user devices, a plurality of service providing platforms configured to provide the plurality of services to the plurality of user devices, and a service management unit configured to, when a message that requests initiation of a first service of the plurality of services is received from a first user device by the communication unit, send a control command for initiating a connection of a first service providing platform, that provides the first service among the plurality of service providing platforms, with the first user device.

The message may be received through a network.

In an aspect of an exemplary embodiment, when the communication unit receives a message that requests initiation of the first service from a second user device, the service management unit may send a control command for initiating a connection of the first service providing platform with the second user device based on status information, and the status information may be generated by the first service providing platform that provides the first service to the first user device.

In an aspect of an exemplary embodiment, when the first service providing platform receives the control command for initiating the connection with the second user device from the service management unit, the first service providing platform may provide the first service to the second user device based on the status information

In an aspect of an exemplary embodiment, the service management unit may establish a session connection, through which the first service is provided from the first service providing platform to the first user device.

In an aspect of an exemplary embodiment, the service management unit may send, to the first service providing platform, a control command for initiating connections of the first service providing platform with the plurality of user devices in response to the message that requests initiation of a first service.

In an aspect of an exemplary embodiment, the service management unit may establish a first session connection, through which the first service is provided from the first service providing platform to the first user device, and establish a second session connection from first service providing platform to a second user device.

In an aspect of an exemplary embodiment, at least one from among a priority and a control authority of the second session may be different from that of the first session.

In an aspect of an exemplary embodiment, if the message that requests the initiation of the first service includes a remote control request, the service management unit may assign a control authority capable of controlling the second user device to the first user device based on the remote control request.

In an aspect of an exemplary embodiment, the control authority may allow the first user device to control an operation of the second user device related to the first service through an interface provided from the first service providing platform.

In an aspect of an exemplary embodiment, when the service management unit receives a remote control request from the first service providing platform, the service management unit may assign a control authority capable of controlling the second user device to the first user device in response to the remote control request.

In an aspect of an exemplary embodiment, when the communication unit receives a message that requests initiation of a second service among the plurality of services from the first user device, the service management unit may send, to a second service providing platform, a control command for initiating a connection of the second service providing platform with the first user device

In an aspect of an exemplary embodiment, when the communication unit receives a message that requests initiation of a second service from the first user device, the service management unit may send a control command for initiating a connection of a second service providing platform with the first user device based on status information, and the status information may be generated by the first service providing platform that provides the first service to the first user device.

In an aspect of an exemplary embodiment, the message that requests initiation of a first service may include at least one from among device information of the first user device and user information of the first user device.

In an aspect of an exemplary embodiment, the message that requests initiation of a first service may be transmitted to the communication unit from a first service client that performs signal processing related to the first service, and a plurality of service clients including the first service may be installed on the first user device.

According to an aspect of another exemplary embodiment, a method for managing a plurality of services is provided. The method may include receiving a message that requests initiation of a first service among the plurality of services from a first user device among a plurality of user devices, sending, to a first service providing platform capable of providing the first service, a first control command for initiating a connection of the first service providing platform with the first user device, and sending a second control command to a second service providing platform capable providing a second service, when a message that requests initiation of the second service different from the first service is received from one of the plurality of user devices.

The message may be received through a network.

The second control command is sent based on status information. The status information may be generated by the first service providing platform that provides the first service to the first user device.

According to the above-described aspects of the exemplary embodiments, the service management unit may be connected between the multiple number of user devices and the plurality of service providing platforms and intervenes between the user devices and the service providing platforms. Accordingly, since each service providing platform need not establish a session connection for each device, resources of the service providing platforms can be efficiently managed.

### BRIEF DESCRIPTION OF THE DRAWINGS

Non-limiting and non-exhaustive exemplary embodiments will be described in conjunction with the accompanying drawings. Understanding that these drawings depict only several exemplary embodiments in accordance with the disclosure and are, therefore, not intended to limit its scope, the disclosure will be described with specificity and detail through use of the accompanying drawings, in which:

FIG. 1 is a diagram illustrating a configuration of a service management apparatus in accordance with an exemplary embodiment of the present disclosure;

FIG. 2 is a flowchart for describing a service management method in accordance with an exemplary embodiment;

FIG. 3 is a flowchart for describing a service management method in accordance with an exemplary embodiment of the present disclosure; and

FIG. 4 is a flowchart for describing a service management method in accordance with another exemplary embodiment of the present disclosure.

### DETAILED DESCRIPTION OF EXEMPLARY EMBODIMENTS

Hereinafter, exemplary embodiments will be described in detail with reference to the accompanying drawings so that the present inventive concept may be readily implemented by those skilled in the art. However, it is to be noted that the present disclosure is not limited to the exemplary embodiments, but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

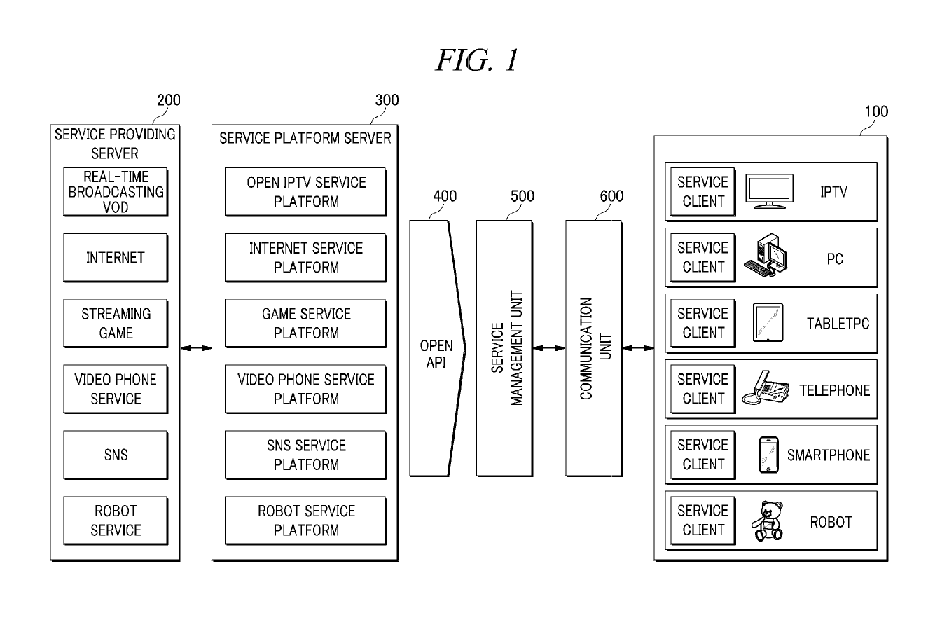

FIG. 1 is a diagram illustrating a configuration of a service management apparatus in accordance with an exemplary embodiment.

As depicted in FIG. 1, the service management apparatus includes a multiple number of devices 100, a service providing server 200, a service providing platform server 300, an open API 400, a service management unit 500 and a communication unit 600.

The multiple number of devices 100 may include an IPTV (Internet Protocol Television), a computer, a tablet computer, a wireless phone, a wireless phone, a robot, etc. Each of the devices 100 has a screen for visually displaying an image. Further, a client program (i.e., a service client in FIG. 1) is installed and operated in each device 100. The service client checks the current state of the device and is capable of executing a service provided from the service management unit 500.

The service providing server 200 provides various services such as IPTV real-time broadcasting and VOD broadcasting, Internet, a streaming game service, a video phone service, a SNS service, a home robot video monitoring service and a control service.

The service providing platform server 300 is a server configured to modify the service requested by a device to be suitable for the specification of the device. The service providing platform server 300 may include an open IPTV service platform, an Internet service platform, a game service platform, a video phone service platform, a SNS service platform, a robot service platform, and so forth. Each platform is connected with the service management unit 500 via the open API 400.

The service management unit 500 is connected with the service providing platform server 300 via the open API 400 and also connected with the multiple number of devices 100 via the communication unit 600.

The communication unit 600 is capable of receiving a first message requesting initiation of one service among the different kinds of services from a device and is also capable of receiving a second message requesting a remote control of another device.

Here, the first message may include at least one from among device information and user information. The second message may include at least one from among information of the device that has requested the remote control of another device, information of the other device as a target of the remote control, remote control target service information and user information.

The service management unit 500 in accordance with the exemplary embodiment is connected between the multiple number of devices 100 and a plurality of service providing platforms. In response to a message from a device 100, the service management unit 500 transmits a control command to a service providing platform that provides a service corresponding to the received message among the plurality of service providing platforms, thus allowing the device that has transmitted the message and the service providing platform that provides the requested service to be session-connected.

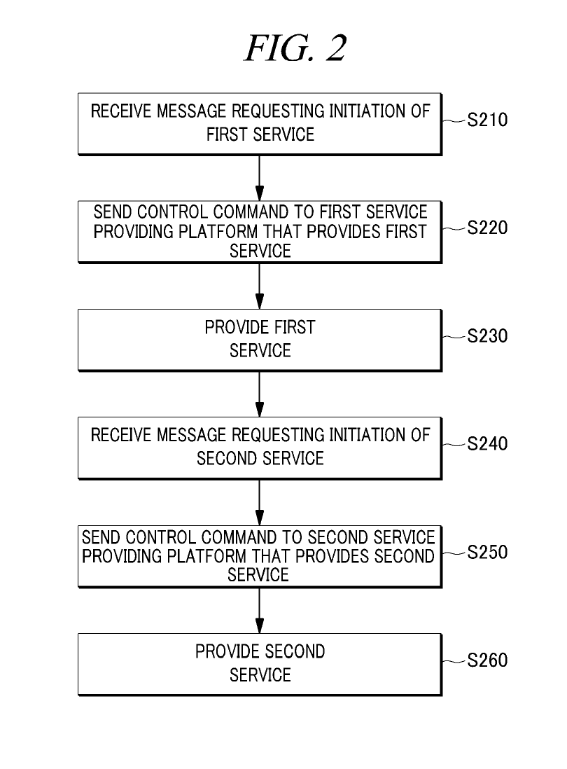

Now, a service management method of the service management unit 500 will be described in further detail with reference to FIG. 2.

FIG. 2 is a flowchart for describing a service management method in accordance with an exemplary embodiment.

As shown in FIG. 2, the service management unit 500 receives a first message requesting a first service among various services from one (hereinafter, referred to as a “first device”) of the multiple number of devices 100 (S210). Then, based on the received first message, the service management unit 500 sends a control command to a first service providing platform that provides the first service, among the multiplicity of platforms (S220). Then, the first service providing platform is session-connected with the first device and the first service can be provided to the first device (S230).

While the first service is being provided to the first device, if a first message requesting initiation of a second service different from the first service is received from the first device or another device (hereinafter, referred to as a “second device) among the multiple number of devices 100 (S240), the service management unit 500 sends a control command to a second service providing server that provides the second service (S250). Then, the second service providing service is session-connected with the second device and the second service can be provided to the first device or another device (S260).

As stated above, in accordance with the exemplary embodiment, the service management unit 500 is connected and intervenes between the multiple number of devices 100 and the plurality of service providing platforms. Accordingly, each service providing platform need not establish a session connection to each device, and, thus, resources of the service providing platforms can be effectively managed.

To elaborate, if the first device requests the first service, the service management unit 500 in accordance with the exemplary embodiment allows the first service providing platform that provides the first service to be session-connected to the first device. Meanwhile, if the second device requests the second service, the service management unit 500 allows the second service providing platform that provides the second service to be session-connected with the second device.

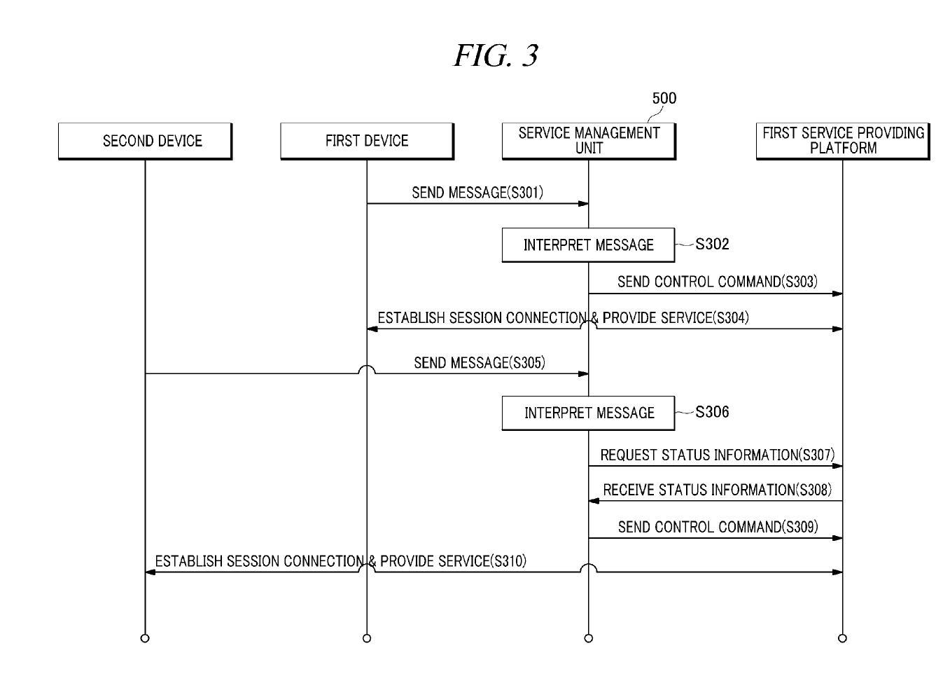

Below, the service management method including the operation of the service management unit 500 will be further elaborated with reference to FIGS. 3 to 5.

FIG. 3 is a flowchart for describing a service management method in accordance with an exemplary embodiment. In FIG. 3, there will be described a service management method for providing a first service being executed in a first device to a second device that is different from the first device.

As shown in FIG. 3, the service management unit 500 in accordance with the exemplary embodiment receives a first message requesting initiation of a certain service from a first device among multiple devices 100 through the communication unit 600 (S301).

Here, the first message includes at least one from among information of the first device, user information and information of the service requested by the first device.

The service management unit 500 interprets the information included in the first message (S302).

To elaborate, the service management unit 500 determines which service among the plurality of services has been requested in the first message. In the following description, the service requested by the first device is referred to as a first service, for the convenience of explanation.

The service management unit 500 sends a control command to a first service providing server providing the first service among the multiple service providing platforms to instruct the first providing server to provide the first service to the first device (S303).

Here, the control command may include information of the first device and the first service to be provided to the first device.

In response to the control command, the first service providing platform establishes a session connection to the first device and provides the first service to the first device (S304).

While the first service is being provided to the first device, if a second message requesting initiation of the first service is received from a second device different from the first device (S305), the service management unit 500 interprets the information received from the second device (S306).

In the following, for the convenience of explanation, assume that the second message requesting that the first service being played in the first device be played seamlessly in the second device is received from the second device.

If it is determined that the second message received from the second device requests that the first service being played in the first device be seamlessly played in the second device, the service management unit 500 requests the first service providing platform to send status information generated as the first service is provided to the first device (S307).

Then, the service management unit 500 receives the status information of the first service from the first service providing platform (S308).

Here, the status information may include service provision information such as time when the first service is started to be provided and time when the play of the first service is stopped.

Based on the status information received from the first service providing platform, the service management unit 500 sends a control command to the first service providing platform to instruct the first service providing platform to initiate connection to the second device (S309).

The control command may include information of the second device and the status information of the first service to be provided to the second device.

In response to the control command, the first service providing platform is session-connected to the second device and provides the first service to the second device (S310).

As described above, in accordance with an exemplary embodiment, if the first device requests the first service, the service management unit 500 sends the control command to the first service providing server that provides the first service, thus allowing the first device and the first service providing platform to be session-connected. Further, if the second device requests the first service, the service management unit 500 sends the control command to the first service providing platform that provides the first service, thus allowing the second device and the first service providing platform to be session-connected.

In this process, the first service can be provided from the first device to the second device seamlessly.

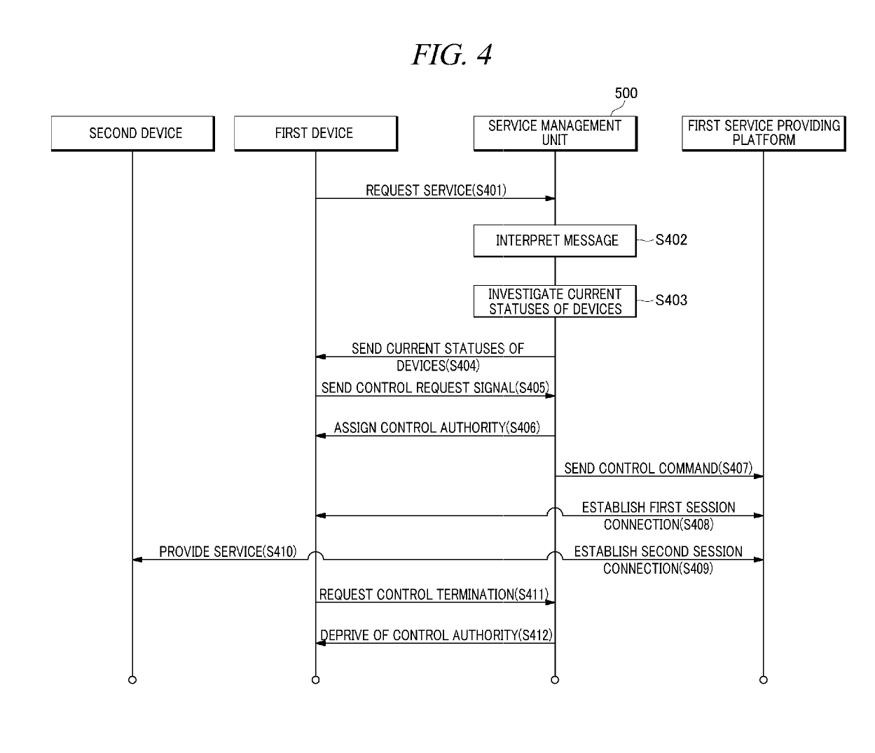

FIG. 4 is a flowchart for describing a service management method in accordance with another exemplary embodiment. In FIG. 4, there will be described a service management method in which a first device selects a certain device among multiple devices depending on current statuses of the devices and the selected device is remote-controlled by the first device.

In FIG. 4, a service that is to be provided to a certain device from the first device is referred to as a first service among a plurality of services, for the convenience of explanation.

As shown in FIG. 4, the first device among the multiple number of devices 100 sends a second message requesting a remote control to the service management unit 500 (S401).

Here, the second message includes information of the first device as a subject that performs the remote control and may also include information of the first service to be provided to the certain device.

The service management unit 500 determines whether the second message requests the remote control and reads the information included in the second message (S402).

Subsequently, the service management unit 500 communicates with service client programs of remote-controllable devices other than the first device and investigates current statuses of those devices (S403).

A current status of a device may be either a standby status in which no service is being executed or a control status in which a service is being executed.

The service management unit 500 transmits the current statuses of the investigated devices to the first device (S404).

The first device selects a second device in a standby status or in a service execution status among the multiple devices and sends a control request signal for requesting a control for the selected second device to the service management unit 500 (S405).

Here, the control request signal may include not only the information of the selected second device but also the information of the first service to be provided to the second device among the plurality of services.

Based on the control request signal, the service management unit 500 assigns control authority for the second device to the first device (S406). Then, based on the control request signal or the second message, the service management unit 500 transmits a control command to the first service providing platform that provides the first service (S407).

Here, the control signal may include the information of the first device as a subject that performs the remote control, the information of the second device as an object of the remote control and the information of the first service that has been requested by the first device to be provided to the second device. Here, the first service may be a service being executed in the first device or a service different from that executed in the first device.

In response to the control command, the first service providing platform establishes a first session connection to the first device (S408) and performs a second session-connection to the second device (S409).

If the first and second session connections are established, the first service providing platform modifies the first service to be suitable for the specification of the second device and then provides the first service to the second device (S410).

While the first and second session connections are maintained, if a control signal requesting another service (e.g., a second service) other than the first service is received from the first device, the service management unit 500 may communicate with a second service providing platform that provides the second service and establish a session connection between the first service providing platform and the first device and a session connection between the second service providing platform and the second device, thus allowing the second service to be provided to the second device.

While the second device is executing another service other than the first service, orders of priority of the first device and the second device are compared. If the control authority of the first device is higher than that of the second device, the first service requested by the first device is executed in the first device.

If, however, the order of priority of the second device is higher than that of the first device, the first service is executed in the first device after the service being currently executed in the second device is completed.

While the second service is being provided to the second device or after the second service is completely provided to the second device, if a control termination signal is inputted to the service management unit 500 from the first device (S411), the service management unit 500 deprives the first device of the control authority (S412).

As stated above, in accordance with the present exemplary embodiment, when a user wants to see a service being executed in the first device in another device seamlessly, a device to be remote-controlled can be selected based on current statuses of the devices. Thus, it is possible to prevent conflicts between the services that might be caused when the first device requests a service to the second device while the second device is executing another service.

In accordance with the exemplary embodiment, the orders of priority of respective devices can be set and modified by the user.

By way of example, assume that a parent outside of the home wants to control a second device (e.g., a robot for an infant) through a first device (e.g., the parent's cellular phone). In this case, even when the second device (robot for an infant) is playing moving picture contents, the execution of the moving picture contents is stopped and control authority is assigned to the first device (the parent's cellular phone).

Then, the parent outside of the home can send an urgent message through the second device (robot for an infant).

As stated above, in accordance with the exemplary embodiment, when the first device attempts to remote-control the second device, if the second device is in a control state, the orders of priority over the second device are compared. Then, by providing control authority to a device having higher order of priority, it is possible to prevent a conflict between services that might be caused when a plurality of devices request the service to the second device.

The exemplary embodiments may be embodied in a transitory or non-transitory storage medium which includes instruction codes which are executable by a computer or processor, such as a program module which is executable by the computer or processor. A data structure in accordance with the exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of the exemplary embodiments is provided for the purpose of illustration, and it will be understood by those skilled in the art that various changes and modifications may be made without changing a technical conception and/or any essential features of the exemplary embodiments. Thus, the above-described exemplary embodiments are illustrative in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of the exemplary embodiments. It shall be understood that all modifications and exemplary embodiments conceived from the meaning and scope of the claims and their equivalents are included in the scope of the present inventive concept.

What is claimed is:

1. An apparatus for managing a plurality of services, the apparatus comprising:
a communication unit configured to receive a message that requests initiation of at least one of the plurality of services from at least one of a plurality of user devices;
a plurality of service providing platforms configured to provide the plurality of services to the plurality of user devices; and
a service management unit configured to, when a message that requests initiation of a first service of the plurality of services is received from a first user device by the communication unit, send a control command for initiating a connection of a first service providing platform, that provides the first service among the plurality of service providing platforms, with the first user device.

2. The apparatus of claim 1, wherein the message is received by the communication unit through a network.

3. The apparatus of claim 1,
wherein when the communication unit receives a message that requests initiation of the first service from a second user device, the service management unit sends a control command for initiating a connection of the first service providing platform with the second user device based on status information, and
wherein the status information is generated by the first service providing platform that provides the first service to the first user device.

4. The apparatus of claim 3,
wherein when the first service providing platform receives the control command for initiating the connection with the second user device from the service management unit, the first service providing platform provides the first service to the second user device based on the status information.

5. The apparatus of claim 1,
wherein the service management unit establishes a session connection, through which the first service is provided from the first service providing platform to the first user device.

6. The apparatus of claim 1,
wherein the service management unit sends, to the first service providing platform, a control command for initiating connections of the first service providing platform with the plurality of user devices in response to the message that requests initiation of a first service.

7. The apparatus of claim 5,
wherein the service management unit establishes a first session connection, through which the first service is provided from the first service providing platform to the first user device, and establishes a second session connection from first service providing platform to a second user device.

8. The apparatus of claim 7,
wherein at least one from among a priority and a control authority of the second session is different from that of the first session.

9. The apparatus of claim 1,
wherein if the message that requests the initiation of the first service includes a remote control request, the service management unit assigns a control authority capable of controlling the second user device to the first user device based on the remote control request.

10. The apparatus of claim 9,
wherein the control authority allows the first user device to control an operation of the second user device related to the first service through an interface provided from the first service providing platform.

11. The apparatus of claim 1,
wherein when the service management unit receives a remote control request from the first service providing platform, the service management unit assigns a control authority capable of controlling the second user device to the first user device in response to the remote control request.

12. The apparatus of claim 1,
wherein when the communication unit receives a message that requests initiation of a second service among the plurality of services from the first user device, the service management unit sends, to a second service providing platform, a control command for initiating a connection of the second service providing platform with the first user device.

13. The apparatus of claim 1,
wherein when the communication unit receives a message that requests initiation of a second service from the first user device, the service management unit sends a control command for initiating a connection of a second service providing platform with the first user device based on status information, and
the status information is generated by the first service providing platform that provides the first service to the first user device.

14. The apparatus of claim 1,
wherein the message that requests initiation of a first service includes at least one from among device information of the first user device and user information of the first user device.

15. The apparatus of claim 1,
wherein the message that requests initiation of a first service is transmitted to the communication unit from a first service client that performs signal processing related to the first service, and
a plurality of service clients including the first service are installed on the first user device.

16. A method for managing a plurality of services, the method comprising:
receiving a message that requests initiation of a first service among the plurality of services from a first user device among a plurality of user devices;
sending, to a first service providing platform capable of providing the first service, a first control command for initiating a connection of the first service providing platform with the first user device; and
sending a second control command to a second service providing platform capable providing a second service, when a message that requests initiation of the second service different from the first service is received from one of the plurality of user devices.

17. The method according to claim 16, wherein the message is received through a network.

18. The method according to claim 16, wherein the second control command is sent based on status information.

19. The method according to claim 18, wherein the status information is generated by the first service providing platform that provides the first service to the first user device.
